(19) United States
(12) Patent Application Publication
(10) Pub. No.: US 2008/0297940 A1
(43) Pub. Date: Dec. 4, 2008

(54) METHOD AND APPARATUS FOR CONTROLLING A NONVOLATILE MEMORY IN A DISK DRIVE

(75) Inventor: Shuichi Kojima, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/110,757

(22) Filed: Apr. 28, 2008

(30) Foreign Application Priority Data
Jun. 4, 2007 (JP) 2007-148211

(51) Int. Cl. G11B 21/02

(52) U.S. Cl. 360/75

(57) ABSTRACT

According to one embodiment, in a disk drive having a disk and a flash memory, the disk controller controls the timing of performing a block erase when the flash memory is accessed, so that this timing may differ from the timing of a seek operation that is performed when the disk is accessed. This prevents the current flowing in the disk drive from exceeding the maximum operating current.

### CROSS-REFERENCE TO RELATED APPLICATIONS

This application is based upon and claims the benefit of priority from Japanese Patent Application No. 2007-148211, filed Jun. 4, 2007, the entire contents of which are incorporated herein by reference.

### BACKGROUND

1. Field

One embodiment of the present invention relates to a disk drive that incorporates a nonvolatile memory such as a flash memory, along with a disk.

2. Description of the Related Art

In recent years, hard disk drives (hereinafter referred to as disk drives) incorporating a flash memory for storing user data, along with a disk, i.e., a magnetic recording medium, have attracted much attention. (See, for example, Jpn. Pat. Apply. KOKAI Publication No. 10-40170.) A disk drive of this type is also called hybrid disk drive.

The flash memory is a nonvolatile semiconductor memory. It is known also as flash electrically erasable programmable read-only memory (EEPROM), in which data can be rewritten in units of blocks.

Such a disk drive as described above can make good use of both a disk that has a large storage capacity and a flash memory that can be accessed at high speed. It is therefore useful as an external storage apparatus for host systems such as personal computers. However, the flash memory must undergo a data-erasing process called block erase, i.e., data-erasing in units of blocks, immediately before data is written into it. To perform the block erase, the flash memory must be supplied with a prescribed current.

Particularly in small disk drives, the power-supply capacity is limited. This imposes a limitation to the maximum current that can be supplied to a small disk drive while the drive is operating. Hence, the current in the small disk drive may exceed the maximum current if accesses are unlimitedly made to both the disk and the flash memory.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the configuration of a disk drive according to any embodiment of the present invention;

FIG. 2 is a diagram showing the waveform of a current supplied while a first embodiment of the invention is performing a seek operation;

FIG. 3 is a diagram showing the waveform of a current supplied while the first embodiment of the invention is performing a seek operation and a block erase;

FIG. 4 is a diagram showing the waveform of a current supplied while a second embodiment of the invention is performing a seek operation and a block erase;

FIG. 5 is a diagram showing the waveform of another current supplied while the second embodiment of the invention is performing a seek operation and a block erase;

FIG. 6 is a diagram showing the waveform of a current supplied while a third embodiment of the invention is performing a seek operation and a block erase;

FIG. 7 is a flowchart explaining the operating sequence of the disk drive according to the first embodiment;

FIG. 8 is a flowchart explaining the operating sequence of the disk drive according to the second embodiment; and

FIG. 9 is a flowchart explaining the operating sequence of the disk drive according to the third embodiment.

### DETAILED DESCRIPTION

Various embodiments according to the invention will be described hereinafter with reference to the accompanying drawings. In general, according to one embodiment of the invention, there is provided a disk drive in which the access to a nonvolatile memory is controlled, thereby preventing the current flowing in the drive from exceeding the maximum operating current.

[Configuration of the Disk Drive]

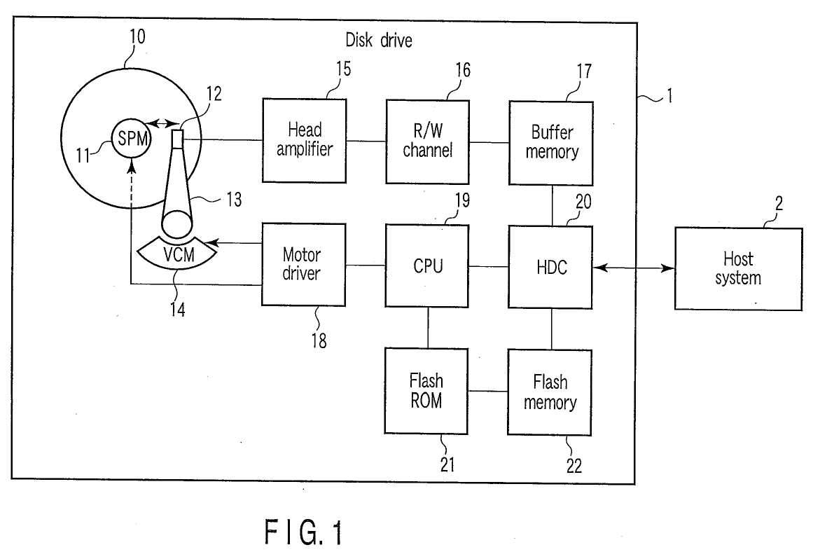

According to an embodiment, FIG. 1 is a block diagram showing the configuration of a disk drive 1 according to any embodiment of the present invention.

The disk drive 1, which is of a type called hybrid disk drive, has a disk 10 and a flash memory 22. The disk 10 is a magnetic recording medium. The flash memory 22 is a nonvolatile semiconductor memory, or a flash EEPROM in which data can be written in units of blocks. The disk drive 1 has a flash memory 21 (hereinafter called flash ROM, for convenience), in addition to the flash memory 22. The flash ROM 21 can be accessed by a microprocessor (CPU) 19 to store various control data items.

The disk drive 1 further has a spindle motor (SPM) 11, a head 12, an actuator 13, and a voice coil motor (VCM) 14. The spindle motor 11 rotates the disk 10. The head 12 has a write head and a read head. The write head can write data to the disk 10. The read head can read data from the disk 10. The actuator 13 holds the head 12. The actuator 13 moves the head 12 over the disk 10, in the radial direction thereof (direction of the arrow), when it is driven by the voice coil motor 14.

The disk drive 1 still further has a head amplifier 15, a read/write (R/W) channel 16, a buffer memory 17, a motor driver 18, a CPU 19, and a disk controller (HDC) 20.

The head amplifier 15 includes a read amplifier and a write amplifier. The read amplifier amplifies any read signal read by the read head of the head 12. The write amplifier converts any write signal output from the read/write channel 16 to a write current, which is supplied to the write head. The read/write channel 16 is a signal-processing circuit and has a read channel and a write channel. The read channel decodes the read signal output from the read head, back to the original data. The write channel encodes the write data supplied from a host system 2.

The buffer memory 17 is a dynamic RAM (DRAM) as in most cases. It is a memory that temporarily stores read/write data under the control of the disk controller 20. The motor driver 18 includes a VCM driver and an SPM driver. The VCM driver controls the voice coil motor 14. The SPM driver controls the SPM 11.

The CPU 19 is the main controller of the disk drive 1 and controls mainly the read/write access to the disk 10. More specifically, the CPU 19 first determines a target position over the disk 10, where a read/write access should be made to the disk 10, and then causes the VCM driver of the motor driver 18 to drive the actuator 13. Thus driven, the actuator 13 moves the head 12 and positions the head 12 at the target position. As in most disk drives, the positioning of the head includes a seek operation for moving the head 12 to the target position and a tracking operation for positioning the head 12 at a target cylinder.

The disk controller 20 is an interface that controls the transfer of read/write data between the drive 1 and the host system 2. In response to a write command given by the host system 2, the disk controller 20 performs a write operation of writing into the memory 22 the write data that has been transferred from the host system 2, and also causes the buffer memory 17 to temporarily store the write data that should be written to the disk 10. The write data is transferred from the buffer memory 17 to the read/write channel 16.

In response to a read command given by the host system 2, the disk controller 20 performs a read operation, transferring data from the buffer memory 17 or from the flash memory 22 to the host system 2. Further, the disk controller 20 performs a read access to the disk 10 in response to a read command supplied from the host system 2. More precisely, the disk controller 20 stores, in the buffer memory 17, the data the read/write channel 16 has decoded.

### FIRST EMBODIMENT

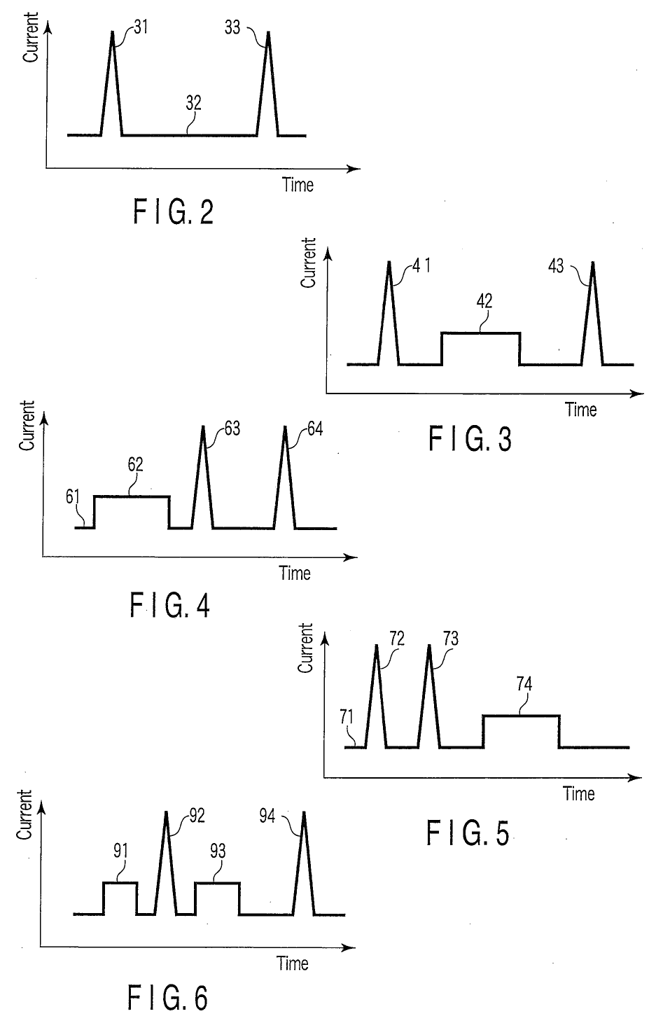

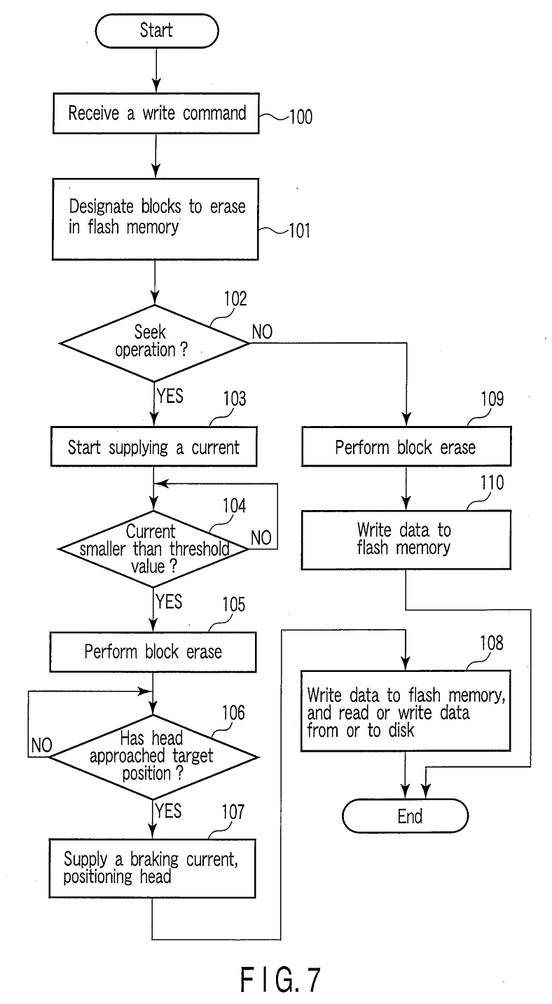

How the disk drive 1 according to this embodiment operates will be explained with reference to FIGS. 2 and 3 and the flowchart of FIG. 7.

In the disk drive 1, the motor driver 18 supplies a current to the VCM 14. The actuator 13 is thereby driven, moving the head 12 in the radial direction of the disk 10 to the target position over the disk 10. This positioning of the head 12 shall be called seek operation. At the target position, the head 12 performs a write operation to write data to the disk 10 or a read operation to read data from the disk 10.

The CPU 19 controls the motor driver 18, which controls the speed of the head 12 performing the seek operation. To be more specific, the motor driver 18 accelerates the head 12 as the head 12 starts moving at head-starting time 31 as shown in FIG. 2, from the standby position over the disk 10. That is, at head-starting time 31, the CPU 19 supplies the maximum rated current (peak current) to the VCM 14.

The head 12 moves at constant speed for a constant-speed moving period 32, approaching the target position over the disk 10. Shortly before the head 12 reaches the target position, the CPU 19 supplies a maximum reverse current (peak reverse current) to the VCM 14 at head-braking time 33, putting a brake on the head 12. The head 12 is thereby stopped at the target position.

The waveform of the current supplied at head-starting time 31 and the waveform of the current supplied at head-braking time 33 differ from each other in normal cases. Nonetheless, they are illustrated as identical in FIG. 2, for the sake of convenience. The seek operation requires tens of milliseconds on average, though it changes with the distance the head 12 is moved to the target position. The current supplied to the VCM 14 during the period between head-starting time 31 and head-braking time 33, i.e., constant-speed motion period 32, is short, not different so much from the period in which the head 12 remains floating above the disk 10.

FIG. 3 is a diagram showing the waveform of the current supplied so that the disk drive 1 may perform a block erase during the seek operation. In the block erase, the disk controller 20 performs an erase process for initializing the flash memory 22, before writes data to the flash memory 22. The initializing of the flash memory 22 is a process of recording only is, in most cases, in units of blocks, thus clearing the flash memory 22. This is why the process is called “block erase.”

In the block erase, a plurality of data blocks are simultaneously erased in some cases. The block erase requires power of, for example, tens of milliwatts to hundreds of milliwatts. Thus, if the block erase is performed at both peaks 41 and 43 of current as shown in FIG. 3, the overall peak current will rise in the disk drive 1, may be exceeding the tolerant maximum value.

In view of this, a control is made in the present embodiment, performing the block erase at times other than the peaks 41 and 43. FIG. 3 is a diagram showing the waveform of the current that is supplied to the flash memory 22 during the block-erase period 42.

The sequence of the control performed in the present embodiment will be explained, with reference to the flowchart of FIG. 7.

The host system 2 supplies a write command to the disk drive 1 to have data saved in the memory 22. The disk drive 1 receives the write command (Block 100). The disk controller 20 determines data blocks (e.g., Blocks 100 and 101) that should be erased (Block 101). Thus, the disk drive 1 will write the data supplied from the host system 2 into the flash memory 22 after the data blocks are erased. In normal cases, the units of data to be written to the flash memory 22 are smaller than the blocks erased.

It is determined whether a seek operation should be performed so that the head 12 may read or write data to or from the disk 10, from the command coming from the host system 2 (Block 102). If a seek operation should not be performed (if NO in Block 102), the disk controller 20 performs the block erase in the flash memory 22 (Block 109). Then, the disk controller 20 writes data to the erased blocks (Block 110).

In Block 102, the CPU 19 may determine that a seek operation should be performed. In this case (if YES in Block 102), the CPU 19 controls the motor driver 18, which supplies a drive current to the VCM 14 (Block 103). In the seek operation, a peak current (maximum rated current) is supplied at seek-starting time 41 in order to accelerate the head 12, as is illustrated in FIG. 3. When the head 12 acquires a constant speed in the seek operation, the current being supplied to the VCM 14 falls below a preset threshold value. It is determined whether the current has fallen below the preset value (Block 104).

The disk controller 20 keeps monitoring the current that decreases with time after the seek-starting time 41. If the current has fallen below the present threshold value (if YES in Block 104), the disk controller 20 performs the block erases (Block 105). That is, the block erase is performed (constant-speed moving period 42) after the seek-starting time 41 (when a peak current is supplied), as is illustrated in FIG. 3. The block erase is completed before seek-braking time 43 in most cases. If the distance the head 12 is moved during the seek operation is short, in some cases, the block erase is not completed.

It is determined whether the head 12 has approached the target position over the disk 10 during the seek operation (Block 106). If YES, the CPU 19 supplies a reverse current (braking current 43) to the VCM 14. The VCM 14 exerts a brake on the head 12, making the head 12 finally stop at the target position (Block 107).

The disk controller 20 writes the data to data blocks have been erased in the flash memory 22 (Block 108). At the same time, the head 12, now positioned at the target position, writes data to the disk 10 or reads data from the disk 10.

Thus, the disk drive 1 according to this embodiment can stably operate at all times even if the power supply has but a limited capacity. This is because the access to the nonvolatile memory is controlled, preventing the operating current from exceeding the maximum value.

To be more specific, the block erase in the flash memory 22 is suspended until the peak current (i.e., maximum rated current) is supplied at seek-starting time 41, if a seek operation is performed while data is being written to the flash memory 22. Then, the block erase is finished before supplying the braking current 43 to the VCM 14.

The control so performed as described above prevents the timing of supplying the peak current during the seek operation from coinciding with the timing of supplying the peak current during the block erase. Hence, the overall current supplied to the disk drive will never exceed the tolerant maximum value. This can suppress the energy consumed while the disk 10 and the flash memory 22 are being accessed. The disk drive 1 can therefore operate in a stable state at all times.

Generally, the block erase is completed in a shorter time than the seek operation performed by the head 12. Therefore, the block erase can be performed during the period 42 between seek-starting time 41 and head-braking time 43, as is illustrated in FIG. 3. Thus, even if the block erase is suspended for some time, the operating efficiency of the disk drive 1 will not decrease so much.

### SECOND EMBODIMENT

FIGS. 4 and 5 are diagrams showing the waveforms of currents supplied while a second embodiment of the invention is performing a seek operation and a block erase. More precisely, FIG. 4 pertains to the case where the block erase is performed before the seek operation, whereas FIG. 5 pertains to the case where the block erase is performed after the seek operation.

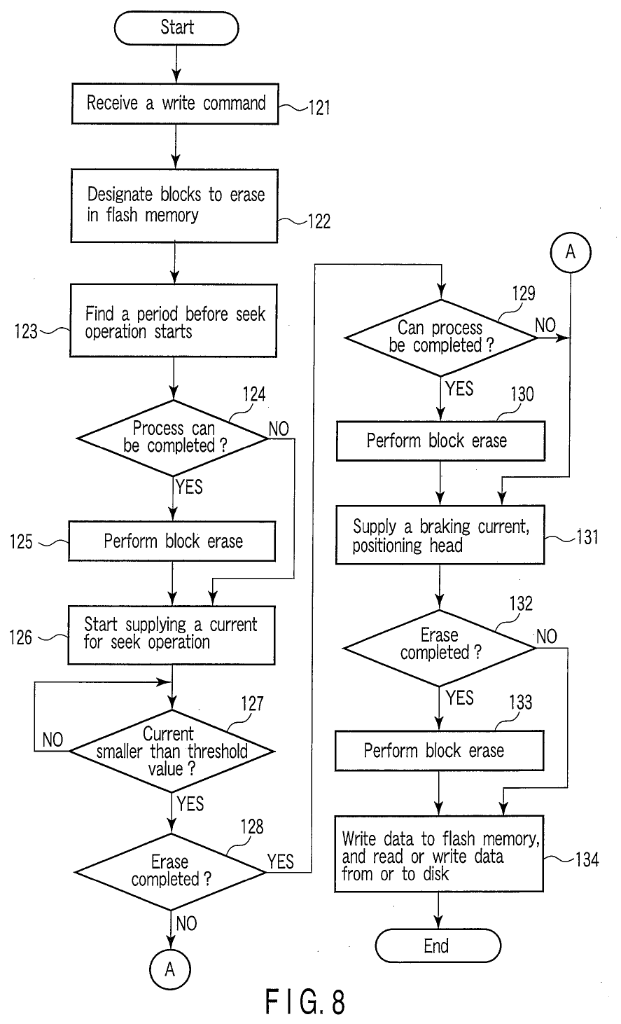

The sequence of control, performed in the second embodiment, will be explained with reference to the flowchart of FIG. 8.

The host system 2 transmits to the disk drive 1 a write command so that the flash memory 22 may save data. In the disk drive 1, the disk controller 20 receives the write command (Block 121). The disk controller 20 then determines data blocks that should be erased (Block 122).

At time 61 shown in FIG. 4, the disk controller 20 calculates the period lasting to the time of starting the seek operation (i.e. peak-current applying time 63) (Block 123). The disk controller 20 then determines whether the period calculated is longer than the time required for a block erase, so that the block erase may be finished before the seek operation starts (Block 124).

If the block erase can be finished before the seek operation starts (if YES in Block 124), the disk controller 20 performs the block erase (at current-supplying time 62) before time 63 when the seek operation is started (Block 125). If the block erase cannot be finished before the seek operation starts (if NO in Block 124), the disk controller 20 suspends the block erase.

The CPU 19 controls the motor driver 18, which supplies a drive current to the VCM 14, to start the seek operation (Block 126). At time 63 when the seek operation is started, a peak current (maximum rated current) is supplied to the VCM 14 in order to accelerate the head 12.

The current supplied decreases as time passes from the seek-operation start time 63 when the seek operation started. Whether the current has decreased to a prescribed value is determined (Block 127). If NO in Block 127, the process returns to Block 127. If YES in Block 127, it is determined whether an erase operation has been performed (Block 128). If YES in Block 128, or if the disk controller 20 determines that the seek operation that started at time 63 is still performed, it is determined whether the block erase can be completed before head-braking time 64 (Block 129).

If YES in Block 129, the disk controller 20 performs a block erase during the period between seek-starting time 63 and head-braking time 64 (Block 130). The period between seek-starting time 71 and the head-braking time 72 may be short as in the case shown in FIG. 5. In this case (if NO in Block 129), the disk controller 20 suspends the block erase.

Then, the CPU 19 supplies a reverse current to the VCM 14 at head-braking time 73, ultimately stopping the head 12 at the target position (Block 131). It is determined again whether an erase operation has been performed (Block 132). If YES in Block 132, the disk controller 20 performs a block erase at current-supplying time 74 (Block 133).

The disk controller 20 performs a write operation, writing data to the flash memory 22 that has been subjected to the block erase (Block 134). The head 12, now at the target position, write data to the disk 10 or read data from the disk 10.

The control described above can prevent the timing of supplying the peak current during the seek operation from coinciding with the timing of supplying the peak current during the block erase. Thus, the overall current supplied to the disk drive will never exceed the tolerant maximum value. This can suppress the energy consumed while the disk 10 and the flash memory 22 are being accessed. The disk drive 1 can operate, always in a stable state.

Moreover, in the present embodiment, the timing of performing a block erase can be selected in accordance with the time that lasts before the seek-starting time or with the time between the seek-starting time and the head-braking time (see FIG. 4 and FIG. 5). Hence, the timing best for the block erase can be determined in accordance with the accessed state of the disk 10.

### THIRD EMBODIMENT

FIG. 6 is a diagram showing the waveform of a current supplied while a third embodiment of the invention is performing a seek operation and a block erase. As FIG. 6 shows, the block erase proceeding 91 is suspended when a seek operation is started at time 92, and is performed again for a constant-speed seek period 93, in the present embodiment.

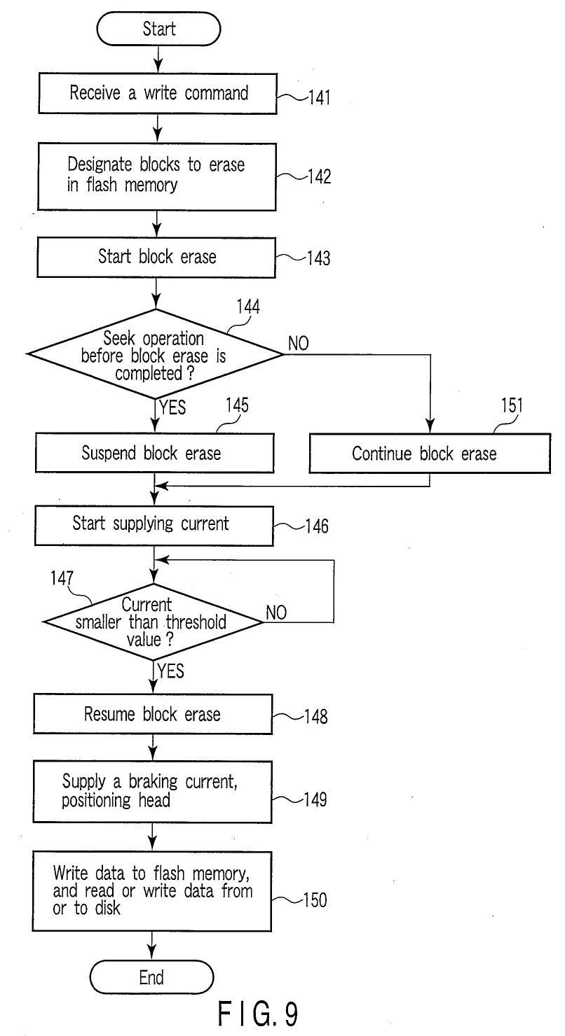

The sequence of control performed in this embodiment will be explained, with reference to the flowchart of FIG. 9.

The host system 2 transmits to the disk drive 1 a write command so that the flash memory 22 may save data. In the disk drive 1, the disk controller 20 receives the write command (Block 141). The disk controller 20 then determines data blocks that should be erased (Block 142).

At time 91 shown in FIG. 6, the disk controller 20 starts a block erase, erasing the blocks already designated (Block 143). Before the block erase is completed, it is determined whether a seek operation should be started in accordance with a command coming from the host system 2, so that data may be read from or written to the disk 10 (Block 144). If YES in Block 144, the disk controller 20 suspends the block erase (Block 145). If NO in Block 144, the disk controller 20 keeps performing the block erase (Block 151).

To start the seek operation, the CPU 19 controls the motor driver 18, which starts supplying a current to the VCM 14 (Block 146). As shown in FIG. 6, the peak current (maximum rated current) is supplied, at seek-starting time 92, to the VCM 14 to accelerate the head 12.

Then, it is determined whether the current supplied to the VCM 14 has decreased to a prescribed threshold value (Block 147). Note that this current falls to the threshold value when the speed at which the head 12 is moving becomes constant during the seek operation. If the current has decreased to the threshold value over the time after the seek-starting time 92 (if YES in Block 147), the disk controller 20 starts again erasing the blocks designated (Block 148). More precisely, the block erase is performed after the seek-starting time 92, for a constant-speed seek period 93 as is illustrated in FIG. 6.

When the head 12 comes near the target position over the disk 10, the CPU 19 supplies a reverse current to the VCM 14 (at head-braking time 94) (Block 149). As a result, the head 12 is stopped at the target position. The disk controller 20 writes data to the data blocks have been erased in the flash memory 22 (Block 150). The head 12 writes data to the target position in the disk 10 or reads data from the target position.

The control described above can prevent the timing of supplying the peak current during the seek operation from coinciding with the timing of supplying the peak current during the block erase. Thus, the overall current supplied to the disk drive will never exceed the tolerant maximum value. This can suppress the energy consumed while the disk 10 and the flash memory 22 are being accessed. The disk drive 1 according to this embodiment can therefore operate, always in a stable state.

Further, in the present embodiment, the block erase is suspended when the seek operation is started and is performed again after the peak current has been supplied to the VCM 14. Hence, before the block erase is performed, the disk controller 20 need not determine when the peak current should be supplied. Thus, the control for determining the timing of the block erase can be efficiently carried out.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk drive comprising:
a head configured to read and write data from and to a disk;
a head-positioning unit configured to position the head at a target position over the disk;
a nonvolatile memory unit having a function of performing a block erase, thereby erasing data in units of blocks, while data is being written; and
a controller configured to control the nonvolatile memory unit, causing the same to perform the block erase while the head-positioning unit is positioning the head, but not while a current supplied to the head-positioning unit remains over a preset upper limit.

2. The disk drive according to claim 1, wherein
the controller performs the block erase to blocks to be erased are designated while data is being written to the nonvolatile memory unit, while the head-positioning unit is positioning the head, but not while a current is being supplied to the head-positioning unit to start and stop positioning the head.

3. The disk drive according to claim 1, wherein during a write operation to the nonvolatile memory, the controller causes the nonvolatile memory to stop the block erase while the current supplied to the head-positioning unit remains at a maximum value during the head positioning, and to perform the block erase while the current remains smaller than the maximum value during the head positioning.

4. The disk drive according to claim 1, wherein during a write operation to the nonvolatile memory, the controller causes the nonvolatile memory to perform the block erase in the case where a time available between the designating of blocks to erase and the starting of the head positioning is long enough to complete the block erase.

5. The disk drive according to claim 1, wherein during a write operation to the nonvolatile memory, the controller causes the nonvolatile memory not to perform the block erase in the case where the head positioning is started after the blocks to erase have been designated, and to perform the block erase after the blocks to erase have been designated.

6. The disk drive according to claim 1, wherein during a write operation to the nonvolatile memory, the controller causes the nonvolatile memory to perform the block erase after the head-position has been completed, in the case where the time required to position the head after designating the blocks to erase is shorter than the time required to complete the block erase.

7. The disk drive according to claim 1, wherein during a write operation to the nonvolatile memory, the controller causes the nonvolatile memory to start erasing blocks before the head positioning is started, to suspend the block erase when the head positioning is started, and to resume the block erase after the head has been accelerated during the head positioning.

8. The disk drive according to claim 1, wherein the controller inhibits data writing to the nonvolatile memory when the block erase is stopped, suspended or not performed.

9. The disk drive according to claim 1, wherein the controller inhibits data reading from into the nonvolatile memory when the block erase is stopped, suspended or not performed.

10. A method of controlling a nonvolatile memory unit in a disk drive that includes a head configured to read and write data from and to a disk, a head-positioning unit configured to position the head at a target position over the disk, and a nonvolatile memory unit having a function of performing a block erase, thereby erasing data in units of blocks, while data is being written, the method comprising:
designating blocks to erase, while data is being written to the nonvolatile memory unit; and
performing the block erase while the head is being positioned, but not while a current supplied to the head-positioning unit remains over a preset upper limit.

11. The method according to claim 10, wherein during a write operation to the nonvolatile memory unit, the block erase is stopped while the current supplied to the head-positioning unit remains at a maximum value during the head positioning, and the block erase is performed while the current remains smaller than the maximum value during the head positioning.

12. The method according to claim 10, wherein during a write operation to the nonvolatile memory unit, the block erase is performed in the case where a time available between the designating of blocks to erase and the starting of the head positioning is long enough to complete the block erase.

13. The method according to claim 10, wherein during a write operation to the nonvolatile memory unit, the block erase is not performed in the case where the head positioning is started after the blocks to erase have been designated, and is performed after the blocks to erase have been designated.

14. The method according to 10, wherein during a write operation to the nonvolatile memory unit, the block erase is performed after the blocks to erase have been designated in the case where the time required to position the head after designating the blocks to erase is shorter than the time required to complete the block erase.

15. The method according to claim 10, wherein during a write operation to the nonvolatile memory unit, the block erase is started before the head positioning is started, is suspended when the head positioning is started, and is resumed after the head has been accelerated during the head positioning.
